(19) United States
(12) Patent Application Publication
(10) Pub. No.: US 2010/0037295 A1
(43) Pub. Date: Feb. 11, 2010

(54) METHOD AND SYSTEM FOR EXCHANGING SECURITY SITUATION INFORMATION BETWEEN MOBILE TERMINALS

(76) Inventors: Seung-Hee OH, Daejeon (KR); Geon Woo KIM, Daejeon (KR); Hyung Kyu LEE, Daejeon (KR); Jong-Wook HAN, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/420,400

(22) Filed: Apr. 8, 2009

(30) Foreign Application Priority Data
Aug. 7, 2008 (KR) 10-2008-0077456

(51) Int. Cl. G06F 15/16

(52) U.S. Cl. 726/3; 709/229

(57) ABSTRACT

In a method for exchanging security situation information between mobile terminals, each of which is connected to a wired/wireless network, security profiles are exchanged between two mobile terminals between which a connection is to be established. The security profiles include security situation information of the mobile terminals, and, each mobile terminal performs a validity check on the received security profile to determine whether security situation of the opponent mobile terminal is trustworthy or not. The connection is established only when the security situations of both mobile terminals are trustworthy.

### CROSS-REFERENCE(S) TO RELATED APPLICATION(S)

The present invention claims priority of Korean Patent Application No. 10-2008-0077456, filed on Aug. 7, 2008, which is incorporated herein by reference.

### FIELD OF THE INVENTION

The present invention relates to a method and system for exchanging security situation information between mobile terminals; and, more particularly, to a method and system for allowing mobile terminals to check each other's validity using security profiles before starting peer-to-peer communications therebetween to thereby establish a connection only between trustworthy mobile terminals.

### BACKGROUND OF THE INVENTION

As well known in the art, P2P (peer-to-peer) communications services are being utilized in information exchange between individuals via wired networks. The P2P communications services include, e.g., file exchange services, chat services via instant messaging and the like.

Meanwhile, most of wired networks traffic, e.g., the Internet traffic, is for the file exchange services, particularly, file exchange services using the P2P communications services. That is, most the Internet traffic is for information exchange between individuals, which means that the information exchange between individuals is one of important Internet services.

The same situation also appears in wireless networks. That is, information exchange between individuals is an important service using Bluetooth communications and forms most of Bluetooth networks traffic, for example.

Under the above-described circumstances, the information exchange between terminals via existing wired/wireless networks has a problem that a terminal can be infected with a malicious code during communications with an untrustworthy terminal. Further, recovering the infected terminal is a time-waste work and changing/repairing the infected terminal causes considerable costs.

### SUMMARY OF THE INVENTION

In view of the above, the present invention provides a method and system for exchanging security situation information between mobile terminals, whereby the mobile terminals are allowed to check each other's validity using security profiles before starting peer-to-peer communications therebetween to thereby establish a connection only between trustworthy mobile terminals.

In accordance with an aspect of the invention, there is provided a method for exchanging security situation information between mobile terminals, each of which is connected to a wired/wireless network, the method including:

transmitting a connection request message from a first mobile terminal to a second mobile terminal;

transmitting, in response to the connection request message, a security profile request message from the second mobile terminal to the first mobile terminal;

transmitting, in response to the security profile request message from the second mobile terminal, a security profile of the first terminal from the first terminal to the second terminal;

performing, at the second mobile terminal, a validity check on the security profile of the first mobile terminal to determine whether security situation of the first mobile terminal is trustworthy or not;

transmitting, when the security situation of the first mobile terminal is determined to be trustworthy, a connection allowance message from the second terminal to the first mobile terminal;

transmitting, in response to the connection allowance message from the second mobile terminal, a security profile request message from the first mobile terminal to the second mobile terminal;

transmitting, in response to the security profile request message from the first mobile terminal, a security profile of the second mobile terminal from the second mobile terminal to the first mobile terminal;

performing, at the first mobile terminal, a validity check on the security profile of the second mobile terminal to determine whether security situation of the second mobile terminal is trustworthy or not; and

transmitting, when the security situation of the second mobile terminal is determined to be trustworthy, a connection allowance message from the first terminal to the second mobile terminal to establish a connection between the first and the second mobile terminals,

wherein the security profiles of the first and the second mobile terminals include the security situation information of the first and the second mobile terminals, respectively.

In accordance with another aspect of the invention, there is provided a system for exchanging security situation information between mobile terminals, each of which is connected to a wired/wireless network, the system including:

a first mobile terminal for transmitting a connection request message; and

a second mobile terminal for receiving the connection request message from the first mobile terminal,

wherein the second mobile terminal transmits a security profile request message to the first mobile terminal in response to the connection request message to receive a security profile of the first mobile terminal, performs a validity check on the security profile of the first mobile terminal to determine whether security situation of the first mobile terminal is trustworthy, and transmits a connection allowance message to the first mobile terminal if the security situation of the first mobile terminal is determined to be trustworthy;

wherein the first mobile terminal transmits a security profile request message to the second mobile terminal in response to the connection allowance message to receive a security profile of the second mobile terminal, performs a validity check on the security profile of the second mobile terminal to determine whether security situation of the second mobile terminal is trustworthy, and transmits a connection allowance message to the second mobile terminal if the security situation of the second mobile terminal is determined to be trustworthy; and

wherein the security profiles of the first and the second mobile terminals include the security situation information of the first and the second mobile terminals, respectively.

According to the present invention, since mobile terminals are allowed to check each other's validity using security profiles before starting peer-to-peer communications therebetween, the mobile terminals can exchange security situation information efficiently.

Further, the method and system of the present invention can preliminarily block distribution of malicious codes, e.g., viruses, worms and the like, thereby saving recovery time and costs from infection with the malicious codes.

### BRIEF DESCRIPTION OF THE DRAWINGS

The above features of the present invention will become apparent from the following description of an embodiment, given in conjunction with the accompanying drawings, in which:

FIG. 1 illustrates a system for exchanging security situation information between mobile terminals in accordance with an embodiment of the present invention;

FIG. 2 illustrates a message flow during a security situation information exchange procedure between mobile terminals in accordance with the embodiment of the present invention;

FIG. 3 illustrates a security profile in accordance with the embodiment of the present invention.

### DETAILED DESCRIPTION OF THE EMBODIMENT

Hereinafter, an embodiment of the present invention will be described in detail with reference to the accompanying drawings, which form a part hereof.

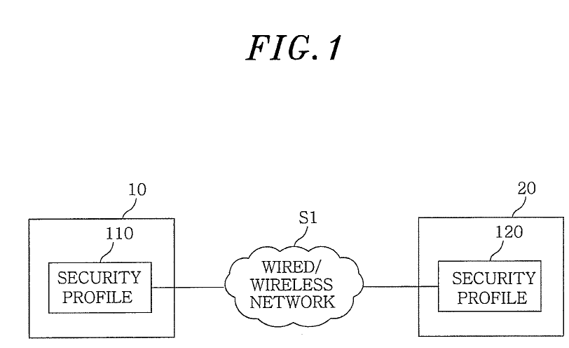

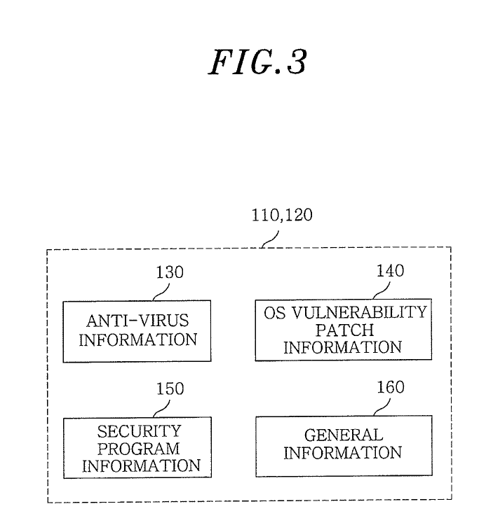

FIG. 1 illustrates a system for exchanging security situation information between mobile terminals in accordance with an embodiment of the present invention. The system includes mobile terminals 10 and 20, each of which is connected to a wired/wireless network S1. The mobile terminals 10 and 20 manage therein security profiles 110 and 120 of FIG. 3 (to be describe in detail later), respectively, as security situation information thereof. After a connection between the mobile terminals 10 and 20 is established using the security profiles 110 and 120, various information are exchanged therebetween.

The wired/wireless network S1 may be any of wireless communications networks and wired communications networks such as the Internet. Particularly, the wireless communications networks may be CDMA (Code Division Multiple Access), W-CDMA (Wideband-CDMA), HSDPA (High-Speed Downlink Packet Access), GSM (Global System for Mobile communications), the firth generation networks and the like including all mobile communications networks to be realized later.

The mobile terminal 10, which is supposed to be a terminal initiating a P2P connection in this disclosure, transmits a connection request message to the mobile terminal 20 via the wired/wireless network S1 and receives a security profile request message from the mobile terminal 20. In response to the security profile request message, the mobile terminal 10 transmits the security profile 110 to the mobile terminal 20 via the wired/wireless network S1.

When receiving a connection allowance message from the mobile terminal 20, the mobile terminal 10 transmits a security profile request message to the mobile terminal 20 via the wired/wireless network S1, and then, performs an authentication and validity check on the security profile 120 received from the mobile terminal 20. If it is determined that security situation of the mobile terminal 20 is trustworthy, the mobile terminal 10 transmits a connection allowance message to the mobile terminal 20 via the wired/wireless network S1 and establishes a connection with the mobile terminal 20.

The mobile terminal 20, which is supposed to be a terminal reacting to the connection request from the mobile terminal 10 in this disclosure, transmits the security profile request message to the mobile terminal 10 via the wired/wireless network S1 in response to the connection request message received from the mobile terminal 10.

When receiving the security profile 110 from the mobile terminal 10, the mobile terminal 20 performs an authentication and validity check on the security profile 110, and, if it is determined that security situation of the mobile terminal 10 is trustworthy, the mobile terminal 20 transmits the connection allowance message to the mobile terminal 10 via the wired/wireless network S1.

Further, when receiving the security profile request message from the mobile terminal 10, the mobile terminal 20 transmits the security profile 120 to the mobile terminal 10 via the wired/wireless network S1.

As describe above, the mobile terminals 10 and 20 are allowed to check each other's validity using security profiles 110 and 120 before starting peer-to-peer communications therebetween. That is, the mobile terminals 10 and 20 can exchange security situation information efficiently.

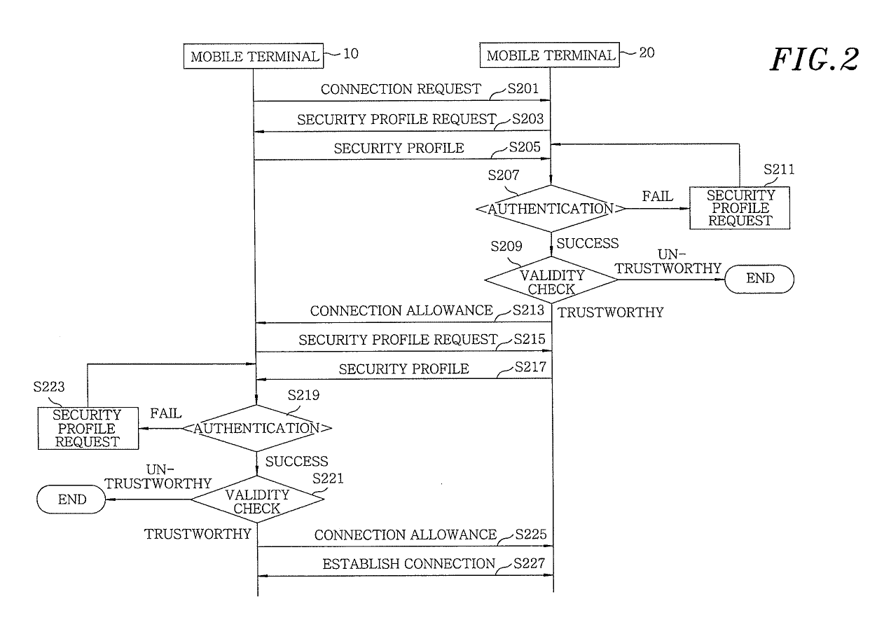

Below, a security situation information exchange procedure between mobile terminals according to the present embodiment will be described with reference to FIGS. 2 and 3.

FIG. 2 illustrates a message flow during a security situation information exchange procedure between mobile terminals in accordance with the embodiment of the present invention.

First, the mobile terminal 10 transmits the connection request message to the mobile terminal 20 via the wired/wireless network S1 (step S201). In response to the connection request message received from the mobile terminal 10 via the wired/wireless network S1, the mobile terminal 20 transmits the security profile request message to the mobile terminal 10 via the wired/wireless network S1 (step S203).

In response to the security profile request message received from the mobile terminal 20 via the wired/wireless network S1, the mobile terminal 10 transmits the security profile 110 to the mobile terminal 20 via the wired/wireless network S1 (step S205). Herein, the security profile 110 includes anti-virus information 130 indicating a list and versions of installed anti-virus software, OS (Operation System) vulnerability patch information 140 indicating updated information of OS vulnerability patch, security program information 150 indicating a list and versions of installed security software and general information 160 indicating basic terminal information such as a device version, an OS version and the like, as shown in FIG. 3. For scalability of the security profile 110 and/or highly secured services, the general information 160 can be selectively excluded from the security profile 110.

When receiving the security profile 110 from the mobile terminal 10 via the wired/wireless network S1, the mobile terminal 20 performs an authentication, e.g., using a public certificate, a PKI (Public Key Infrastructure) or the like, to determine whether the security profile 110 is transmitted by the mobile terminal 10 (step S207). If the authentication fails in the step S207, the mobile terminal 20 transmits again the security profile request message to the mobile terminal 10 via the wired/wireless network S1 (step S211).

If the authentication succeeds in the step S207, the mobile terminal 20 then performs the validity check on the security profile 110 (step S209).

In the step S209, the mobile terminal 20 compares the anti-virus information 130, the OS vulnerability information 140, the security program information 150 and the general information 160 in the security profile 110 with preset security ranges, respectively, to determined whether the security situation of the mobile terminal 10 is trustworthy to establish a connection between the mobile terminals 10 and 20. To be specific, in the step S209, it is checked whether necessary anti-virus software of appropriate versions are installed on the mobile terminal 10, whether necessary OS vulnerability patches are updated in the mobile terminal 10, whether necessary security software of appropriate versions are installed on the mobile terminal 10 and whether the device version, the OS version and the like of the mobile terminal 10 are appropriate to establish the connection.

If it is determined, in the step S209, that the security situation of the mobile terminal 10 is trustworthy, i.e., if it is determined that the information 130 to 160 of the security profile 110 satisfy the preset security ranges, the mobile terminal 20 transmits the connection allowance message to the mobile terminal 10 via the wired/wireless network S1 (step S213). On the other hand, if it is determined, in the step S209, that the security situation of the mobile terminal 10 is un-trustworthy, i.e., if it is determined that the information 130 to 160 of the security profile 110 do not satisfy the preset security ranges, the connection between the mobile terminals 10 and 20 is not established.

When receiving the connection allowance message from the mobile terminal 20 via the wired/wireless network S1, the mobile terminal 10 transmits the security profile request message to the mobile terminal 20 via the wired/wireless network S1 (step S215).

In response to the security profile request message received from the mobile terminal 10 via the wired/wireless network S1, the mobile terminal 20 transmits the security profile 120 to the mobile terminal 10 via the wired/wireless network S1 (step S217). Herein, the security profile 120 includes anti-virus information 130 indicating a list and versions of installed anti-virus software, OS (Operation System) vulnerability patch information 140 indicating updated information of OS vulnerability patch, security program information 150 indicating a list and versions of installed security software and general information 160 indicating basic terminal information such as a device version, an OS version and the like, as shown in FIG. 3. For scalability of the security profile 120 and/or highly secured services, the general information 160 can be selectively excluded from the security profile 120.

When receiving the security profile 120 from the mobile terminal 20 via the wired/wireless network S1, the mobile terminal 10 performs an authentication, e.g., using a public certificate, a PKI (Public Key Infrastructure) or the like, to determine whether the security profile 120 is transmitted by the mobile terminal 20 (step S219). If the authentication fails in the step S219, the mobile terminal 10 transmits again the security profile request message to the mobile terminal 20 via the wired/wireless network S1 (step S223).

If the authentication succeeds in the step S219, the mobile terminal 10 then performs the validity check on the security profile 120 (step S221).

In the step S221, the mobile terminal 10 compares the anti-virus information 130, the OS vulnerability information 140, the security program information 150 and the general information 160 in the security profile 120 with preset security ranges, respectively, to determined whether the security situation of the mobile terminal 20 is trustworthy to establish a connection between the mobile terminals 10 and 20. To be specific, in the step S221, it is checked whether necessary anti-virus software of appropriate versions are installed on the mobile terminal 20, whether necessary OS vulnerability patches are updated in the mobile terminal 20, whether necessary security software of appropriate versions are installed on the mobile terminal 20 and whether the device version, the OS version and the basic information of the mobile terminal 20 are appropriate to establish the connection.

If it is determined, in the step S221, that the security situation of the mobile terminal 20 is trustworthy, i.e., if it is determined that the information 130 to 160 of the security profile 120 satisfy the preset security ranges, the mobile terminal 10 transmits the connection allowance message to the mobile terminal 20 via the wired/wireless network S1 (step S225). Then, the connection between the mobile terminals 10 and 20 is established (step S227).

On the other hand, if it is determined, in the step S221, that the security situation of the mobile terminal 20 is un-trustworthy, i.e., if it is determined that the information 130 to 160 of the security profile 120 do not satisfy the preset security ranges, the connection between the mobile terminals 10 and 20 is not established.

While the invention has been shown and described with respect to the embodiment, it will be understood by those skilled in the art that various changes and modification may be made without departing from the scope of the invention as defined in the following claims.

What is claimed is:

1. A method for exchanging security situation information between mobile terminals, each of which is connected to a wired/wireless network, the method comprising:
transmitting a connection request message from a first mobile terminal to a second mobile terminal;
transmitting, in response to the connection request message, a security profile request message from the second mobile terminal to the first mobile terminal;
transmitting, in response to the security profile request message from the second mobile terminal, a security profile of the first terminal from the first terminal to the second terminal;
performing, at the second mobile terminal, a validity check on the security profile of the first mobile terminal to determine whether security situation of the first mobile terminal is trustworthy or not;
transmitting, when the security situation of the first mobile terminal is determined to be trustworthy, a connection allowance message from the second terminal to the first mobile terminal;
transmitting, in response to the connection allowance message from the second mobile terminal, a security profile request message from the first mobile terminal to the second mobile terminal;
transmitting, in response to the security profile request message from the first mobile terminal, a security profile of the second mobile terminal from the second mobile terminal to the first mobile terminal;
performing, at the first mobile terminal, a validity check on the security profile of the second mobile terminal to determine whether security situation of the second mobile terminal is trustworthy or not; and
transmitting, when the security situation of the second mobile terminal is determined to be trustworthy, a connection allowance message from the first terminal to the second mobile terminal to establish a connection between the first and the second mobile terminals,
wherein the security profiles of the first and the second mobile terminals include the security situation information of the first and the second mobile terminals, respectively.

2. The method of claim 1, wherein each security profile includes:
anti-virus information indicating a list and versions of installed anti-virus software;
operating system vulnerability patch information indicating updated information of operating system vulnerability patch;
security program information indicating a list and versions of installed security software; and
general information indicating basic terminal information such as a device version, an operating system version and the like.

3. The method of claim 2, wherein each validity check is performed by comparing the anti-virus information, the operating system vulnerability patch information, the security program information and the general information with preset security ranges, respectively.

4. The method of claim 3, wherein, in each validity check, the security situation of the mobile terminal by which the security profile being checked is transmitted is determined to be trustworthy when anti-virus software of appropriate versions necessary to establish the connection are installed thereon, when operating system vulnerability patches necessary to establish the connection are updated therein, when security software of appropriate versions necessary to establish the connection are installed thereon and when the device version, the operating system version and the basic information thereof are appropriate to establish the connection.

5. The method of claim 1, wherein the connection is not established if it is determined that the security situation of the first mobile terminal and/or the second mobile terminal are/is not trustworthy.

6. The method of claim 1, wherein the validity check on the security profile of the first mobile terminal includes performing an authentication to determine whether the security profile of the first terminal is transmitted by the first mobile terminal, and, the validity check on the security profile of the second mobile terminal includes performing an authentication to determine whether the security profile of the second terminal is transmitted by the second mobile terminal.

7. The method of claim 6, wherein each authentication is performed using a public certificate.

8. The method of claim 6, wherein each authentication is performed using a public key infrastructure.

9. The method of claim 6, wherein, the second mobile terminal transmits again the security profile request message to the first mobile terminal when the authentication on the security profile of the first mobile terminal fails, and the first mobile terminal transmits again the security profile request message to the second mobile terminal when the authentication on the security profile of the second mobile terminal fails.

10. A system for exchanging security situation information between mobile terminals, each of which is connected to a wired/wireless network, the system comprising:
a first mobile terminal for transmitting a connection request message; and
a second mobile terminal for receiving the connection request message from the first mobile terminal,
wherein the second mobile terminal transmits a security profile request message to the first mobile terminal in response to the connection request message to receive a security profile of the first mobile terminal, performs a validity check on the security profile of the first mobile terminal to determine whether security situation of the first mobile terminal is trustworthy, and transmits a connection allowance message to the first mobile terminal if the security situation of the first mobile terminal is determined to be trustworthy;
wherein the first mobile terminal transmits a security profile request message to the second mobile terminal in response to the connection allowance message to receive a security profile of the second mobile terminal, performs a validity check on the security profile of the second mobile terminal to determine whether security situation of the second mobile terminal is trustworthy, and transmits a connection allowance message to the second mobile terminal if the security situation of the second mobile terminal is determined to be trustworthy; and
wherein the security profiles of the first and the second mobile terminals include the security situation information of the first and the second mobile terminals, respectively.

11. The system of claim 10, wherein each security profile includes:
anti-virus information indicating a list and versions of installed anti-virus software;
operating system vulnerability patch information indicating updated information of operating system vulnerability patch;
security program information indicating a list and versions of installed security software; and
general information indicating basic terminal information such as a device version, an operating system version and the like.

12. The system of claim 11, wherein each validity check is performed by comparing the anti-virus information, the operating system vulnerability patch information, the security program information and the general information with preset security ranges, respectively.

13. The system of claim 12, wherein, in each validity check, the security situation of the mobile terminal by which the security profile being checked is transmitted is determined to be trustworthy when anti-virus software of appropriate versions necessary to establish the connection are installed thereon, when operating system vulnerability patches necessary to establish the connection are updated therein, when security software of appropriate versions necessary to establish the connection are installed thereon and when the device version, the operating system version and the basic information thereof are appropriate to establish the connection.

14. The system of claim 10, wherein the connection is not established if it is determined that the security situation of the first mobile terminal and/or the second mobile terminal are/is not trustworthy.

15. The system of claim 10, wherein the validity check on the security profile of the first mobile terminal includes performing an authentication to determine whether the security profile of the first terminal is transmitted by the first mobile terminal, and, the validity check on the security profile of the second mobile terminal includes performing an authentication to determine whether the security profile of the second terminal is transmitted by the second mobile terminal.

16. The system of claim 15, wherein each authentication is performed using a public certificate.

17. The system of claim 15, wherein each authentication is performed using a public key infrastructure.

18. The system of claim 15, wherein, the second mobile terminal transmits again the security profile request message to the first mobile terminal when the authentication on the security profile of the first mobile terminal fails, and the first mobile terminal transmits again the security profile request message to the second mobile terminal when the authentication on the security profile of the second mobile terminal fails.
